(19) United States
(12) Patent Application Publication
(10) Pub. No.: US 2015/0003489 A1
(43) Pub. Date: Jan. 1, 2015

(54) Installation for Treating a Fuel to Increase its Caloric Power

(71) Applicant: Aurel Enache, Ploiesti (RO)

(72) Inventor: Aurel Enache, Ploiesti (RO)

(21) Appl. No.: 14/380,240

(22) PCT Filed: Mar. 5, 2013
(86) PCT No.: PCT/RO2013/000006

§ 371 Date: Aug. 21, 2014

(30) Foreign Application Priority Data
Mar. 12, 2012 (RO) A2012 00164

(51) Int. Cl. F27D 11/02

(52) U.S. Cl. CPC F27D 11/02
USPC 373/109

(57) ABSTRACT

The invention refers to an installation for treating fuels to increase their caloric power. The installation, according to the claimed invention has a housing (15) and a coupon (10) between which there are place some excitation units (A), each of these as are attached to each of two wires (11 and 12) which follow a spiral path through the coupon (10).

The invention refers to an installation for treating a gaseous fuel like natural gases, biogas, hydrogen, refinery gases or other alike, as well as some liquid fuels like gasoline, diesel, oil, kerosene, avgas and others alike, and other solid fuels like coal, wood, combustible shale, charcoal, cox, semi-cox, coal briquettes, solid fuel for rockets, solid fuel waste (woodchips, sawdust, seed shells, myriads and others alike) to increase their caloric power.

There are installations that increase the combustion energy of a gaseous fuel that include some electromagnetic units, which are placed around a pipe that is made out of a diamagnetic material, as well as some metallic cores that are touching the pipe through which the preheated natural gas circulates, those cores being arranged in sections of three units each, each section being rotated from the previous section by an angle in the range of 70°-73°, so between the first and the last section there is a full 360° rotation, the electromagnetic units being placed in the orifices of a thermal insulated support, each electromagnetic unit containing a metallic core, placed in an electric coil, a heat exchanging reservoir with the role of maintaining a constant temperature of the electromagnetic unit and several electrical connection heads, in the interior of the reservoir the oil used as a thermal agent being introduced through a pipe and being taken from it through an evacuation pipe, the pipes having equal diameters, but the admission pipe being longer than the other one, the ratio of lengths equal to 2 . . . 2.5, through the admission pipe of a unit and the evacuation pipe of the following unit the linking of all the heat exchanging reservoirs being made, the ratio of the pipe that crosses the reactor and the natural gas pipeline having a value of 3 . . . 6—Patent RO 121655 B1.

The disadvantages of those installations are the following: they require a large amount of electricity to create and maintain the electromagnetic field, they require the usage of several subassemblies with the role of cooling the electromagnetic units and preheating the natural gas which are not viable in case the gaseous fuel is a gas resulting from the decomposition process of organic substances because the magnetic moments induced in the fuel are opposing the magnetic field developed by the electromagnetic units and a diminishing of the field takes place.

The technical problem that the installation, according to the claimed invention fixes is to reduce the electricity needed for treatment of the gaseous fuel, provided that it contains air, respectively CO₂ or other non-combustible gases and the increase of the caloric power in the case of liquid or solid fuels.

The installation, according to the claimed invention removes the disadvantages shown before and resolves the technical problem because between a metal housing and a coupon mounted inside the admission pipe there exists an annular space in which there are placed two excitation units, each one having inside two semi-fittings made out of 99.99% contaminated electrolytic copper, and between them there are several insulation spaces, in front of the first space several electrodes are placed which are long, thread-like, good electrical conductors, insulated at the exterior, connected to an AC power source with a high, variable frequency, in the interior of the semi-fittings there are placed several electrodes which are circular, superior and inferior, made out of electrolytic copper, and between them and the contact is placed a circular, thick component made out of a material with dielectric properties, such as optical glass, contaminated, and attached to the circular electrodes are several connectors which are thread-like, short, protected by electrical insulation, connected to the aforementioned power source, and in the interior of the coupon in permanent contact there are some non-insulated wires that are in contact with each other which follow a spiral path, in front of every spire the long thread-like electrodes, which are individually attached to each wire protrude through the coupon.

Another objective of the installation according to the claimed invention is that the materials which the semi-fittings and the circular piece are made of are contaminated (of the same concentration—parts million) with a noble metal, preferably platinum.

Another objective of the installation according to the claimed invention is that the circular piece has a thickness that is proportional to the voltage applied to the circular electrodes according to the relation (1):

$$\frac{V}{d} < 3 \cdot {10}^{6} [ \frac{V}{m} ] \qquad ( 1 )$$

in which
d represents the thickness of the circular piece and
V—the voltage applied to the electrodes.

Another objective of the installation according to the claimed invention is that the high, variable frequency AC power source has a voltage value of 0.01 . . . 15 mV and a frequency value of 10 . . . 100 GHz in the case of gaseous fuels, 16 . . . 18 GHz in the case of liquid fuels, 17 . . . 23 GHz in the case of solid vegetable fuels and 29.5 GHz . . . 100 GHz in the case of solid fuels like coal.

Another objective of the installation according to the claimed invention is that the continuous power source has a voltage power of 3000 . . . 5000 V, depending on the thickness of the circular thick piece, to ensure an electric field with the value of 3·10⁵ . . . 3·10⁶ V/m.

The installation according to the claimed invention has the following advantages:
it requires a relatively low electricity consumption for the treatment of the fuel to increase its caloric power;
it has a relatively low gauge and mass, allowing easy transportation and handling;
it allows the treatment of gaseous fuels which contain air, CO₂ or other non-combustible gases;
it allows the treatment of a large array of gaseous, liquid and solid fuels to increase their caloric power;
it allows a relatively simple construction that does not affect the exterior environment, the materials that it uses being recyclable;
it allows the control and command for different increases of the initial caloric power of the fuel.

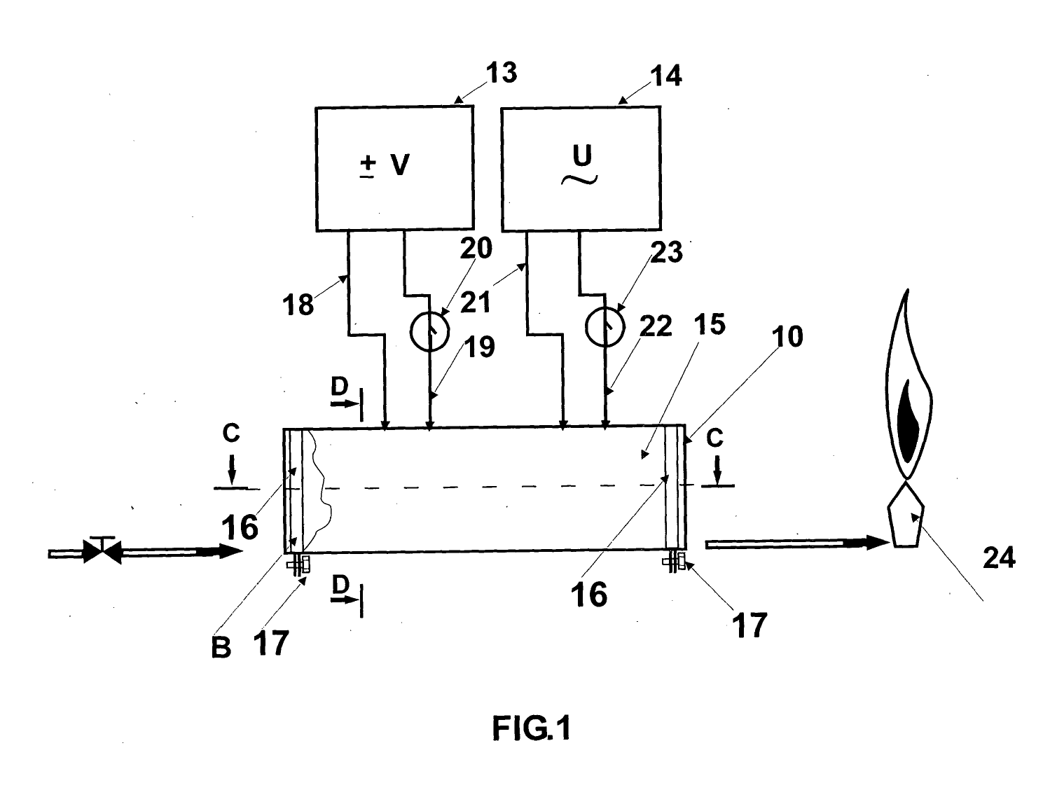

The following two examples as to how the installation according to the claimed invention is realized are given below, according to FIGS. 1 . . . 10, which represent:

FIG. 1, the block schematic of the installation according to the claimed invention;

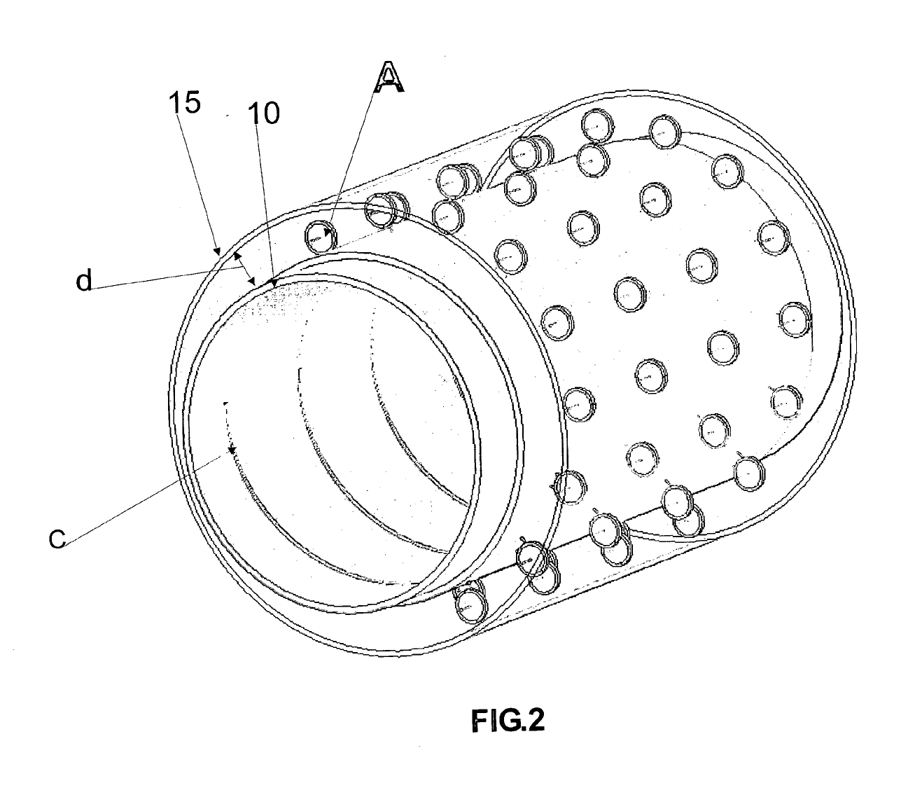

FIG. 2, the B constructive detail as seen in FIG. 1;

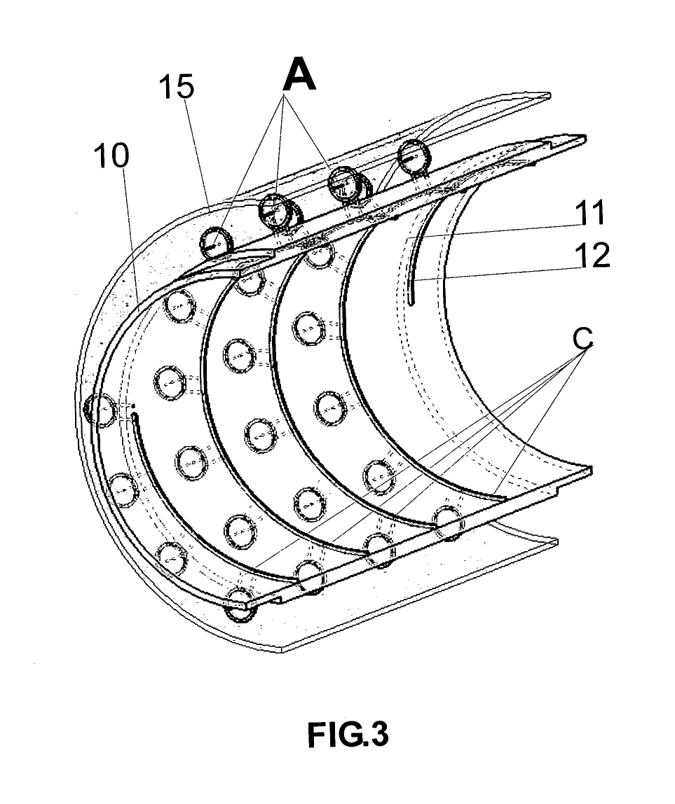

FIG. 3, section of the C-C plane as seen in FIG. 1 through the liquid fuel pipe;

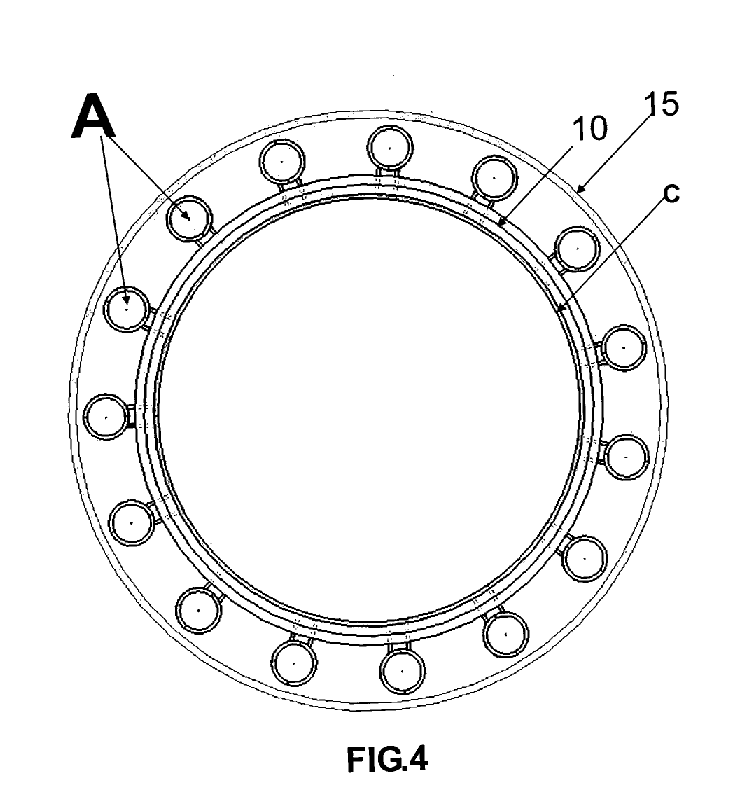

FIG. 4, transversal section of the D-D plane as seen in FIG. 1 through the liquid fuel pipe;

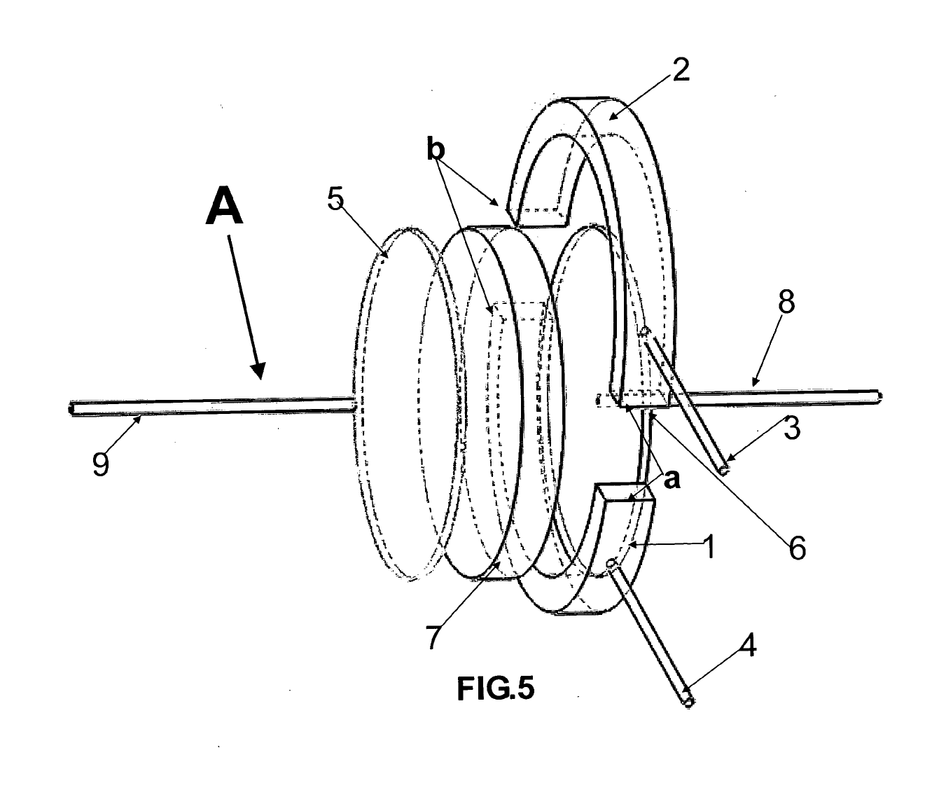

FIG. 5, perspective view of an excitation unit, part of the installation according to the claimed invention;

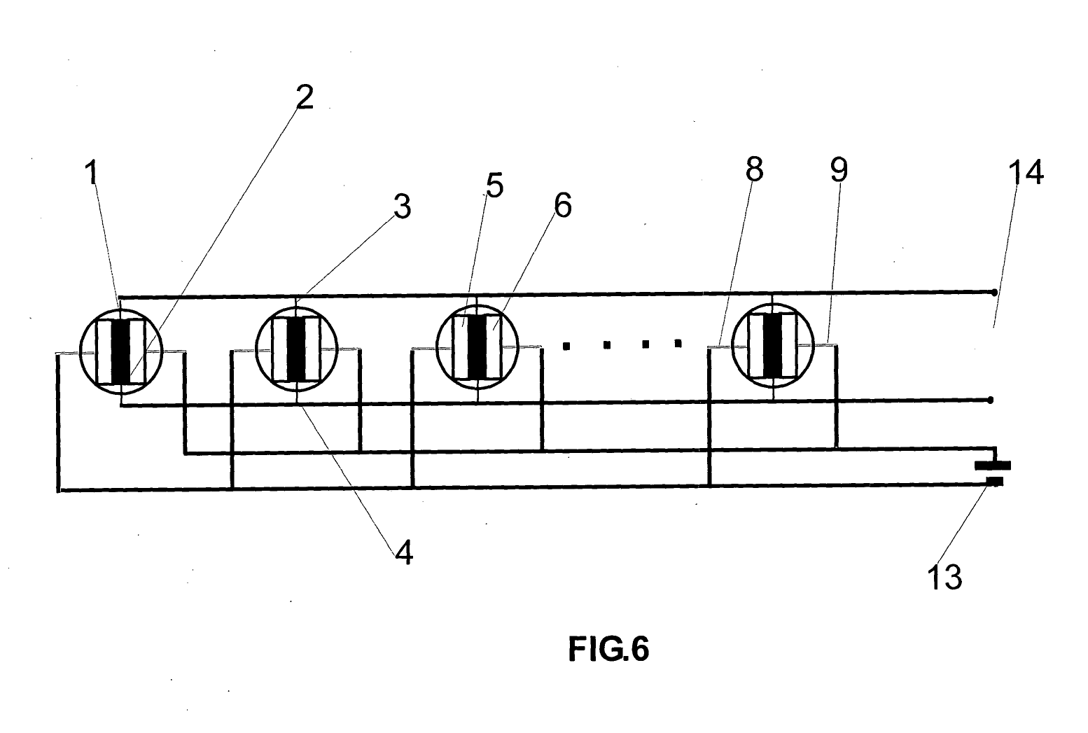

FIG. 6, general schematic of the power supply of the excitation unit;

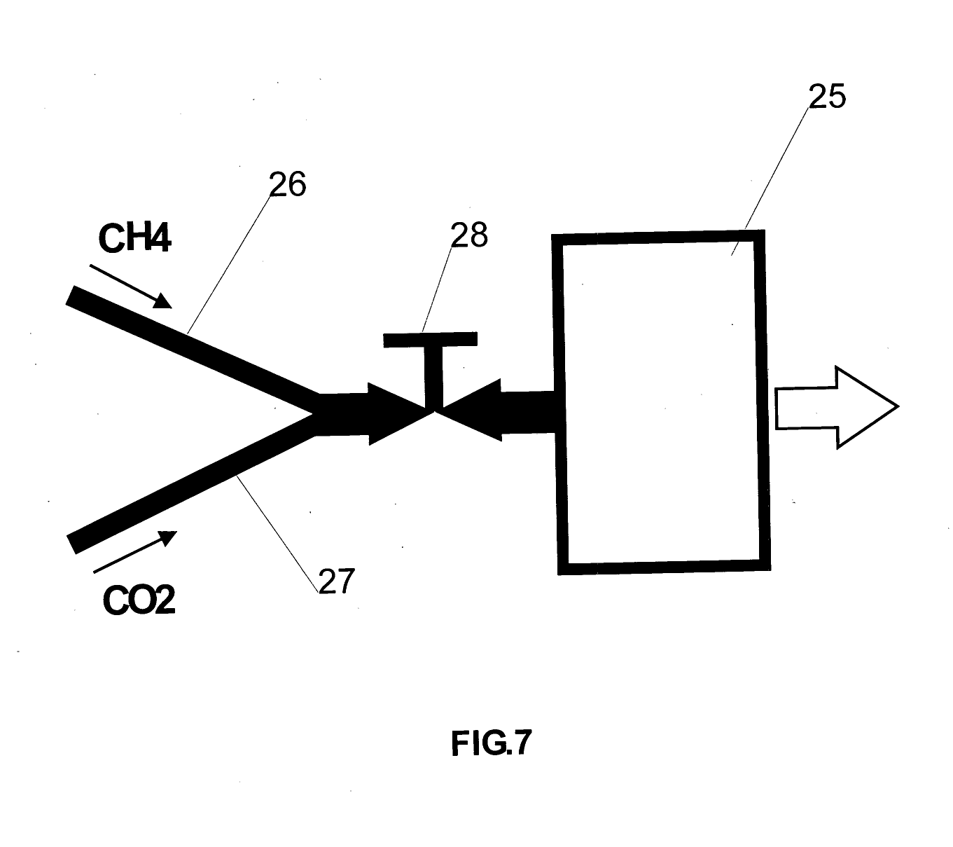

FIG. 7, schematic of the determination with a calorimeter of the caloric power of biogas;

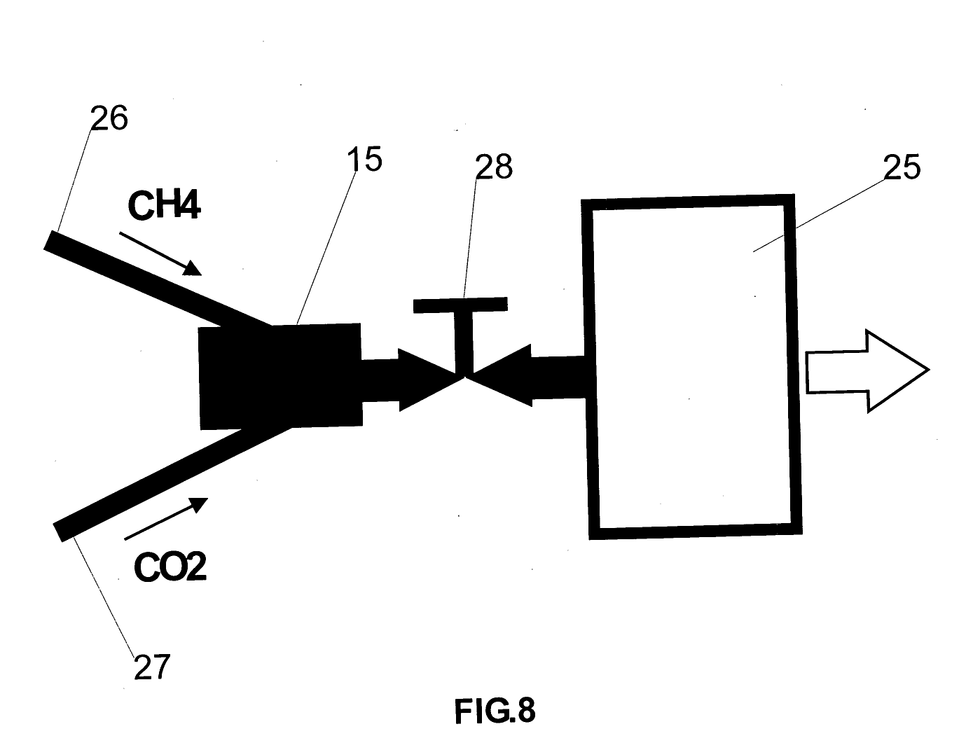

FIG. 8, schematic of the determination with a calorimeter of the caloric power of biogas, circulating through the installation according to the claimed invention;

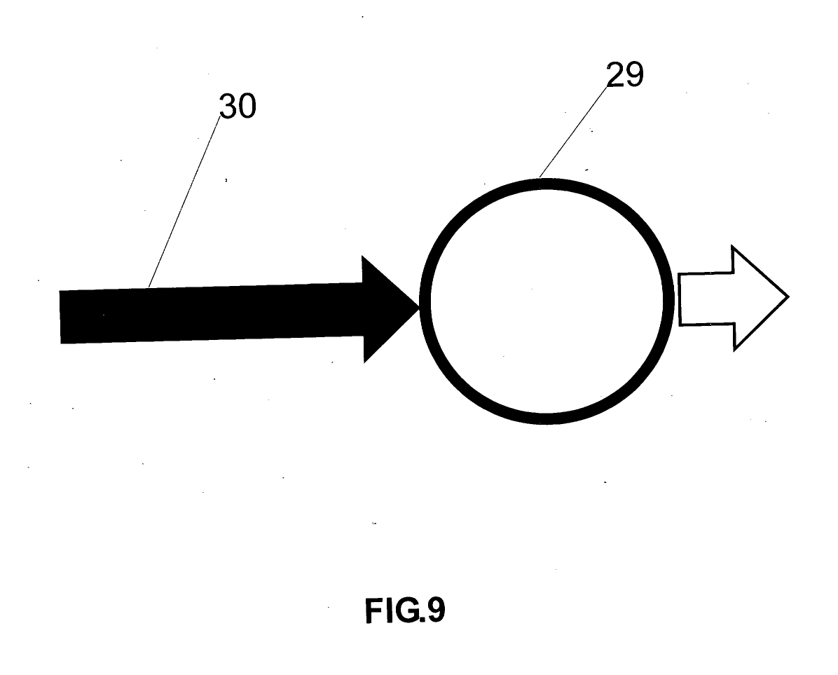

FIG. 9, schematic of the determination with a calorimetric bomb of the caloric power of coal, diesel, gasoline or other similar fuels;

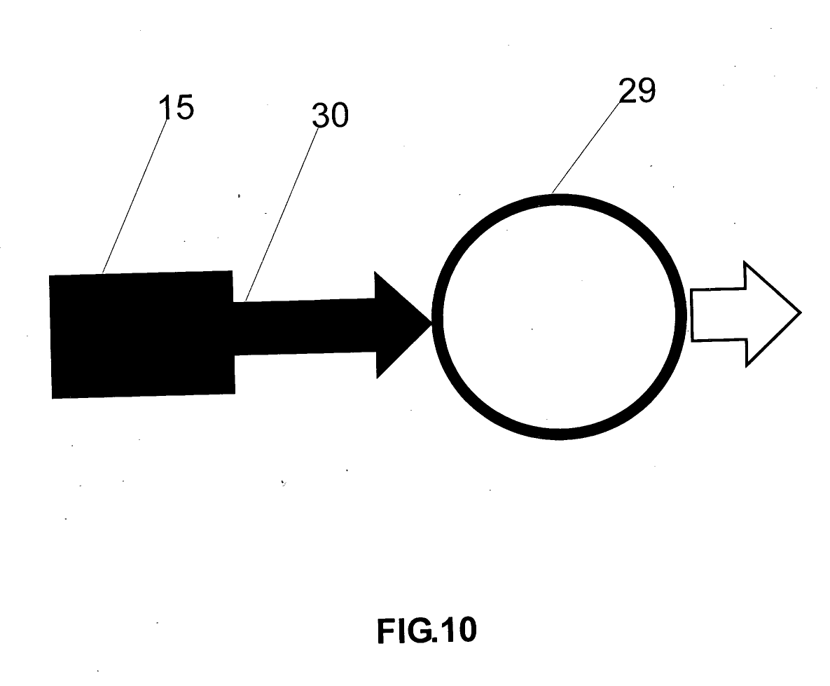

FIG. 10, schematic of the determination with a calorimetric bomb of the caloric power of coal, diesel, gasoline or other similar fuels, after they pass through the installation according to the claimed invention.

The installation according to the claimed invention is built from several A excitation units, which have two semi-fittings 1 and 2, between which, in a functioning position, there remain some spaces a and b to isolate each other. Each of the 1 and 2 semi-fittings is made out of electrolytic copper 99.99%, copper that is contaminated by the order of parts per million with a noble metal, preferably platinum.

In front of the a space attached to the 1 and 2 semi-fittings are the 3 and 4 electrodes which are long, threadlike, made out of a good electrical conductor, preferably copper, insulated on the exterior.

Inside the 1 and 2 semi-fittings are placed the 5 and 6 circular, inferior and superior, electrodes which are made out of electrolytic copper. Between the 5 and 6 electrodes and in contact with the two is placed a thick circular piece (7) which has a thickness proportional to the voltage applied to the 5 and 6 electrodes, according to the relation (1):

$$\frac{V}{d} < 3 \cdot {10}^{6} [ \frac{V}{m} ] \qquad ( 1 )$$

in which:
d represents the thickness of the circular piece 7, and
V—the voltage applied to the electrodes 5 and 6.

The 7 piece is obtained from a material with dielectric properties, like optical glass, contaminated in the same concentration as the material with which the 1 and 2 semi-fittings are contaminated, for example platinum.

Attached to the 5 and 6 electrodes, centrally, are two 8 and 9 threadlike connectors which are short and electrically insulated.

In the interior of the 10 coupon which is placed inside a conduct, not positioned in the figures, through which a gas passes such as methane, biogas, refinery gas, cox oven gas, gas from the burning of wood including hydrogen or other gases or mixes of combustible gases—the gaseous phase of liquid fuels is also included—are placed in direct contact with the coupon two wires 11 and 12, not insulated, which are in contact with each other and are attached to the coupon through pasting. The 11 and 12 wires follow a spiral path and make a 15° . . . 30° angle with a transversal plane.

In front of each c spire formed by the 11 and 12 wires and the 10 coupon, on the exterior are fixes the 3 and 4 electrodes of the 1 and 2 semi-fittings, which are in contact with the 11 and 12 wires.

The density A of the excitation units is 100 . . . 700 units A/m².

The 8 and 9 short, threadlike connectors of each A excitation unit are connected to the “+” and “−” poles of a continuous power source 13. The value of the power is dependant on the thickness of the 7 piece, to ensure an electrical field required to polarize the electron orbits of the platinum atoms with which the 7 piece is contaminated.

Every 3 and 4 threadlike, long electrodes are connected to 14 an AC power source with high, variable frequency. The 14 AC power source provides AC power with different frequencies for gaseous fuels, liquid fuels such as gasoline, diesel, liquefied petroleum gas and other similar fuels, and for solid vegetal fuels such as wood, seed shells, wood wastes and others alike, and for fuels such as coal and others alike.

The A excitation units are placed in an annular space d, delimited on the side by the 10 coupon and a 15 housing, made out of an electrically insulating material, which is attached to the 10 coupon using a 16 clamp fixed with the 17 bolts.

The 8 and 9 connectors are powered from the 13 source through the 18 and 19 conductors, the 20 switch being placed along them, and the 3 and 4 electrodes are connected to the 14 power source using the 21 and 22 conductors which a 23 switch placed along them.

Further along the 15 housing the 10 coupon is connected with a pipe to the 24 gas burner.

To treat the fuel that circulates through the 10 coupon with a temperature equal to that of the surrounding environment, the 5 and 6 electrodes are charged with power through the 8 and 9 connectors from the 13 source, and the 3 and 4 electrodes are powered from an AC, high frequency source 14. The working value of the AC, high frequency voltage is chosen depending on the nature of the material used to contaminate the 1 and 2 semi-fittings and of the 7 piece (which in this case, is made out of platinum) and the nature of the fuel.

As a result of the contact of the 3 and 4 electrodes with the c spiral in the 10 coupon, through which the fuel passes, an internal rotating electromagnetic field is generated which converts a fraction of the resting energy of the fuel molecule that it had before the contact with the 11 and 12 wires into chemical bonding energy between the constituent atoms of the fuel molecule, leading to an increase of its caloric power.

The contaminations represented by the platinum have the role of forming electromagnetic fields that are circularly polarized, when the constituent electrons of the electron shells of the platinum atoms are excited using a variable electrical field induced by the 1 and 2 semi-fittings into the impurities of the piece 7 using the 14 power source. When the circular polarization takes place the vector of the electric field of the electromagnetic wave rotates over the direction of the propagation of the electromagnetic wave and gives it a rotary effect.

The electromagnetic waves produced then propagate into the c spires in the 10 coupon through the 3 and 4 threadlike, long electrodes. In turn, the c spires radiate an electromagnetic wave that is circularly polarized, that rotates, changing the energy levels of the electron spins in the atoms of the fuel.

Through an electromagnetic coupling of the electrons in the c spires and the electron spins in the electron shells of the fuel molecule, a change of the state of quantic numbers which define the total energy of the fuel atoms happens, change which then makes possible the conversion of the resting energy of the fuel molecule into chemical bonding energy between the constituent atoms of the fuel molecule.

When producing circularly polarized electromagnetic fields and having a resonance frequency for each type of fuel that is treated in the installation according to the claimed invention an increase in the caloric power of the fuels takes place, which is confirmed by the tests made with different types of fuels which are shown below.

In the situation when the installation according to the claimed invention was tested with natural gas, the specific consumption measurements were made using a hot water boiler (HWB), with the production capacity of 10 Mwh.

The following specific consumptions of the HWB were tested in the following two situations:
without using the installation according to the claimed invention;
using the installation according to the claimed invention:

The following parameters were measured: temperature t, pressure p and debit d using specific approved instruments which are:
thermocouples for temperatures;
flowmeters for water and natural gas;
pressure probes for the gas pressure in the network of the 24 burner with which the HWB is equipped.

The installation according to the claimed invention has a length of 2 m and the diameter of the coupon 10 is 27 cm.

Using the temperature of the water, entering/exiting into/out of the HWB and the water debit each hour the energy is calculated (expressed in Gcal).

At the same time the volume of the gas that has been consumed is measured in normal cubic meters, Nmc.

The ratio between the volume of the gas measured in Nmc and the energy measured in Gcal represents the specific consumption monitored during the measurements.

Based on the data provided by the Table nr. 1 and Table nr. 2 it is observable that this specific consumption when the installation according to the claimed invention wasn't used has a value of 142.27 Nmc/Gcal, and when the installation according to the claimed invention was used it has a value of 107.5 Nmc/Gcal.

TABLE NR. 1
OPERATION OF HWB WITHOUT THE
INSTALATION ACCORDING TO THE
CLAIMED INVENTION OVER 24 H

| | Con- | Entry | Exit | | | | |
|---|---|---|---|---|---|---|---|
| Hour | sump- | temper- | temper- | | Instant | Q | |
| of mea- | tion | ature | ature | | water | HWB/ | Nmc/ |
| suring | mc/h | in HWB | in HWB | Δt | debit | 1000 | Gcal |
| 0:00 | 1189 | 59 | 81.5 | 22.5 | 385.2 | 8.67 | 137.19 |
| 1:00 | 1270 | 58 | 82.6 | 24.6 | 398.4 | 9.80 | 129.58 |
| 2:00 | 1200 | 58 | 82.6 | 24.6 | 402 | 9.89 | 121.34 |
| 3;00 | 1134 | 58 | 81.7 | 23.7 | 434.4 | 10.30 | 110.15 |
| 4:00 | 1191 | 58 | 82.2 | 24.2 | 427.8 | 10.35 | 115.04 |
| 5:00 | 1214 | 58 | 82.4 | 24.4 | 444 | 10.83 | 112.06 |
| 6:00 | 1254 | 56 | 78.2 | 22.2 | 214 | 4.76 | 263.71 |
| 7:00 | 1199 | 56 | 81.6 | 25.6 | 188.4 | 4.82 | 248.60 |
| 8:00 | 1107 | 58 | 83.4 | 25.4 | 205.8 | 5.23 | 211.77 |
| 9:00 | 1299 | 59 | 84.9 | 25.9 | 442.8 | 11.47 | 113.27 |
| 10:00 | 1494 | 52 | 74.7 | 22.7 | 437.5 | 9.93 | 150.43 |
| 11:00 | 946 | 55 | 78.8 | 23.8 | 441 | 10.50 | 90.13 |
| 12:00 | 1141 | 57 | 78.9 | 21.9 | 423 | 9.26 | 123.17 |
| 13:00 | 1109 | 58 | 78.5 | 20.5 | 455.4 | 9.34 | 118.79 |
| 14:00 | 1202 | 58 | 76.6 | 18.6 | 440.1 | 8.19 | 146.84 |
| 15:00 | 1185 | 58 | 76.5 | 18.5 | 449.4 | 8.31 | 142.53 |
| 16:00 | 1274 | 56 | 75.9 | 19.9 | 448.8 | 8.93 | 142.65 |
| 17:00 | 1123 | 57 | 75.5 | 18.5 | 462.6 | 8.56 | 131.22 |
| 18:00 | 1212 | 58 | 79.6 | 21.6 | 400.8 | 8.66 | 140.00 |
| 19:00 | 1194 | 58 | 79.5 | 21.5 | 411 | 8.84 | 135.12 |
| 20:00 | 1182 | 58 | 79.6 | 21.6 | 411.2 | 8.88 | 133.08 |
| 21:00 | 1126 | 58 | 79.5 | 21.5 | 406.2 | 8.73 | 128.93 |
| 22:00 | 1162 | 58 | 80.2 | 22.2 | 396.6 | 8.80 | 131.98 |
| 23:00 | 1198 | 58 | 79.9 | 21.9 | 399.6 | 8.75 | 136.89 |
| 0:00 | | | | 0.0 | | 0 | |
| AVG. | 1191.88 | 57.38 | 79.78 | 24.16 | 396.93 | 8.73 | 142.27 |

TABLE NR. 2
OPERATION OF HWB WITH THE INSTALAT1ON ACCORDING
TO THE CLAIMED INVENTION OVER 24 H

| | Con- | Entry | Exit | | | | |
|---|---|---|---|---|---|---|---|
| Hour | sump- | temper- | temper- | | Instant | Q | |
| of mea- | tion | ature | ature | | water | HWB/ | Nmc/ |
| suring | mc/h | in HWB | in HWB | Δt | debit | 1000 | Gcal |
| 11:15 | — | — | — | — | — | — | |
| 12.00 | 584 | 65 | 81.1 | 16.1 | 600.3 | 9.66 | 60.4 |
| 13:00 | 695 | 68.5 | 83.1 | 14.6 | 511.6 | 7.47 | 93.0 |
| 14:00 | 844 | 68 | 81.9 | 13.9 | 405.0 | 5.63 | 149.9 |
| 15:00 | 680 | 68 | 74.8 | 6.8 | 559.2 | 3.80 | 178.8 |
| 16:00 | 497 | 68 | 75.1 | 7.1 | 543.6 | 3.86 | 128.8 |
| 17:00 | 526 | 68 | 75.1 | 7.1 | 532.8 | 3.78 | 139.0 |
| 18:00 | 489 | 68 | 75.9 | 7.9 | 548.4 | 4.33 | 112.9 |
| 19:00 | 572 | 68 | 78.5 | 10.5 | 575 | 6.04 | 94.7 |
| 20:00 | 943 | 67 | 78.6 | 11.6 | 605.1 | 7.02 | 134.3 |
| 21:00 | 882 | 67 | 79.4 | 12.4 | 577.5 | 7.16 | 123.2 |
| 22:00 | 912 | 68 | 79.6 | 11.6 | 530.9 | 6.16 | 148.1 |
| 23:00 | 602 | 67 | 80.2 | 13.2 | 541 | 7.14 | 84.3 |
| 0.00 | 748 | 67 | 80.2 | 13.2 | 527.4 | 6.96 | 107.4 |
| 1:00 | 563 | 68 | 80.3 | 12.3 | 511.2 | 6.29 | 89.5 |
| 2:00 | 579 | 68 | 80.2 | 12.2 | 512.4 | 6.25 | 92.6 |
| 3:00 | 609 | 68 | 80.4 | 12.4 | 502.8 | 6.23 | 97.7 |
| 4:00 | 563 | 68 | 81 | 13 | 455.4 | 5.92 | 95.1 |
| 5:00 | 528 | 70 | 80.1 | 10.1 | 450 | 4.55 | 116.2 |
| 6:00 | 570 | 69 | 80 | 11 | 526.5 | 5.79 | 98.4 |
| 7:00 | 630 | 67 | 79.9 | 12.9 | 599.7 | 7.74 | 81.4 |
| 8:00 | 689 | 68 | 80 | 12 | 600.9 | 7.21 | 95.6 |
| 9:00 | 608 | 68 | 80 | 12 | 610.2 | 7.32 | 83.0 |
| 10:00 | 677 | 68 | 80.4 | 12.4 | 608.1 | 7.54 | 89.8 |
| 11:00 | 607 | 68 | 79.7 | 11.7 | 609 | 7.13 | 85.2 |
| AVG. | 649.88 | 67.81 | 79.40 | 11.6 | 543.50 | 6.29 | 107.5 |

During the experiment in which the installation according to the claimed invention was used, the value of the voltage was 3500 V, ensuring an electric field power of 2.7·10⁶ V/m, the frequency of the AC voltage was of 12.4 Ghz, and the value of the AC voltage was of 2 mV.

Regarding the density of the A excitation units, it had a value of 118 units A/m².

The ratio of the two specific consumptions is 1.323.

The thermal energy encompassed by the water is calculated using the relation (2):

Q_{water}=M·Δt·Cp, (2)
in which:
Q_{water} represents the thermal energy encompassed by the water, measured in Gcal,
M—the mass of the water that encompasses the Q_{water},
Δt—the difference in temperature at which the water reaches through heating, and
Cp—the specific heat of the water which is 0.998 kcal/kg·degree Celsius.

During the experiment through the usage of the installation according to the claimed invention there was a consumption of energy for powering the 13 and 14 sources equal to 0.1 Kwh and an increase in the energy of the gas of 32.3% compared to the situation in which the installation according to the claimed invention was not used, provided that the caloric power of the untreated gaseous combustible was approximately 6619 Kcal/Nmc gas, and after the treatment of the gas it reached 8785 Kcal/Nmc gas.

The determination of the increase in the caloric power of the biogas using the installation according to the invention takes place with the following considerations:

From a chemical point of view, biogas is a mixture of natural gas, carbon dioxide and slight traces of hydrogen sulphide and has in its composition between 50% and 90% CH4 compared of the total volume and between 10% and 40% CO2 of the total volume and between 0-0.1% H2S of the total volume.

To fabricate the biogas in laboratory conditions the natural gas is mixed with CO2 in various proportions, then this mixture is burned in a Junkers calorimeter 25 to establish the caloric power, in two ways, according to the schematics presented in FIGS. 8 and 9.

The methane gas along with the carbon dioxide, with or without the hydrogen sulphide, travels through the 26 and 27 pipes towards the calorimeter 25 attached through a faucet 28. In this calorimeter the initial caloric power of the mixture that is determined.

The methane gas along with the carbon dioxide, with or without the hydrogen sulphide, travels through the 26 and 27 pipes towards the 10 coupon, placed in the housing 15 along with the A unit, attached through the faucet 28 with the 25 calorimeter. In this calorimeter the caloric power of the mixture that has been treated is determined.

Three batches of biogas were fabricated L₁, L₂ and L₃, using CH4 from the home network and CO2 from a gas tank. The three batches L₁, L₂ and L₃ have the following chemical compositions and initial caloric powers at 15 degrees Celsius and the standard atmospheric pressure for the estimation of the caloric power for one normal cubic meter of biogas:
Batch L₁ contains 50% CH4 and 50% CO2 and has an initial caloric power of 2940 Kcal/Nmc;
Batch L₂ contains 70% CH4 and 30% CO2 and has an initial caloric power of 3520 Kcal/Nmc;
Batch L₃ contains 90% CH4 and 10% CO2 and has an initial caloric power of 4715 Kcal/Nmc.

The three batches are taken through the installation according to the claimed invention to increase their caloric power and the following caloric power values are obtained:
Batch L₁ has a caloric power after treatment in the installation according to the claimed invention of 3881.6 Kcal/Nmc;
Batch L₂ has a caloric power after treatment in the installation according to the claimed invention of 4787 Kcal/Nmc;
Batch L₃ has a caloric power after treatment in the installation according to the claimed invention of 6695.3 Kcal/Nmc.

Therefore the increase in caloric power for batch L₁ is of 32%, for batch L₂ is of 35.9% and for batch L₃ the increase in the caloric power is of 42%.

The average of these measurements is of 36.63%.

It is observable that a higher content of CO2 in the volume of biogas leads to a smaller increase in the caloric power when treated with the installation according to the claimed invention.

The installation according to the claimed invention used for treating the three batches L₁, L₂ and L₃ of biogas has a length of 0.15 m and the diameter of the coupon 10 is of 0.03 m.

During these measurements in which the installation according to the claimed invention was used, the voltage value was of 3500 V, ensuring an electric field power of 2.7·10⁶ V/m.

The frequency of the AC power was of 12.2 Ghz and the value of the AC power was of 0.8 mV.

Regarding the density of the A units of excitation, this had a value of 110 units A/m².

During this experiment, through the usage of the installation according to the claimed invention an amount of 9 Wh of power was used for powering the 13 and 14 power sources and an average of 36.3% increase in the caloric power of the three treated batches L₁, L₂ and L₃ of biogas was obtained.

To measure the initial caloric powers of other combustibles of solid or liquid nature, as well as establishing the superior caloric powers of them after the treatment in the installation according to the claimed invention, the fuel mixture is stoichiometrically prepared for each fuel in part, mixture which is composed of the fuel itself and oxygen, thus using a calorimetric bomb 29 the caloric powers of them in a normal state can be established, as well as after they are treated in the installation according to the claimed invention.

The 29 calorimetric bomb is a piece of equipment dedicated to the measurements of the caloric powers of different solid and liquid fuels.

The installation according to the claimed invention used for treating coal has a length of 0.15 m and the coupon 10 diameter of 0.03 m.

Coal dust, diesel or other fuels alike are taken through a pipe 30 into the bomb 29 in which the burning takes place, which allows the measurement of the caloric power.

During these measurements in which the installation according to the invention was used, the coal dust, diesel and other fuels alike are taken through the coupon 10 into the housing 15 together with the A units and then taken through the 30 pipeline.

The value of the voltage is 3500 V, generating an electric power field with a value of 2.7·10⁶ V/m.

The frequency of the AC voltage was 16.3 Ghz for gasoline and 16.5 Ghz for diesel, and the value of the AC voltage was of 0.65 mV.

The frequency of the AC voltage was 24.2 Ghz for coal and the value of the AC voltage was of 0.65 mV.

Regarding the density of the A units of excitation, it had a value of 110 units A/m².

During this experiment, when using the installation according to the claimed invention an amount of 90 Wh of power was used to power the 13 and 14 sources.

The following initial caloric powers were measured for:
Gasoline has an initial caloric power of 4892 Kcal/kg;
Diesel has an initial caloric power of 5715 Kcal/kg;
Coal has an initial caloric power of 3720 Kcal/kg.

The following caloric powers were measured after the treatment using the installation according to the claimed invention:
Gasoline has a caloric power after the treatment using the installation according to the claimed invention of 6408 Kcal/kg;
Diesel has a caloric power after the treatment using the installation according to the claimed invention of 7601 Kcal/kg;
Coal has a caloric power after the treatment using the installation according to the claimed invention of 4743 Kcal/kg.

When treating these combustibles using the installation according to the claimed invention the increase in caloric power is of 31% for gasoline, 33% for diesel and 27.3% for coal.

1. An installation for treating a fuel to increase its caloric power, which is mounted along an admission pipe for a gaseous combustible, liquid or solid fuel of an industrial consumer, a burner and which has a DC power source, as well as a housing, characterised by an annular space between a housing and a connecting cylindrical piece mounted with the admission pipe, wherein the annular space contains excitation units, each excitation unit having two fittings, each having an exterior, wherein said fittings are made out of electrolytic copper 99.99% contaminated with a noble metal, wherein between said fittings there are two isolation spaces, in front of a first isolation space two electrodes are fixed which are electrical conductors and part of the fittings, insulated on the exterior and connected to an AC power source with a high, variable frequency and at the exterior of the fittings are placed two electrodes which are circular, made out of electrolytic copper, and between said circular electrodes and in contact with them being placed a circular piece which is made out of a material with dielectric properties, contaminated with a noble metal, and the circular electrodes are also connected to the connectors which are short and electrically insulated and connected to the DC power source, and in the interior of the connecting cylindrical piece and in non-removable contact with these being placed two electrically insulated wires which are in contact with each other, which follow a spiral path, in front of each spire through the connecting cylindrical piece protruding the electrodes which are fixed to each wire.

2. The installation according to claim 1, wherein the fittings and the circular piece are contaminated with a noble metal in the same concentration, by the order of parts per million.

3. The installation according to claim 1, wherein the circular piece has a thickness directly proportional with the voltage applied to the circular electrodes according to the relation (1):
$$\frac{V}{d} < 3 \cdot {10}^{6} [ \frac{V}{m} ] \qquad ( 1 )$$
in which:
d represents the thickness of the circular piece, and
V—the voltage applied to the electrodes.

4. The installation according to claim 1, wherein the AC power source with a high, variable frequency has a voltage value of 0.01 to 15 mV and a frequency of 10 to 100 Ghz for gaseous combustibles, of 16 to 18 Ghz for liquid fuels, 17 to 23 Ghz for solid vegetable fuels and 29.5 to 100 Ghz for solid fuels.

5. The installation according to claim 3, wherein the voltage provided by the DC power source has a value of 3000 to 5000 V, depending on the thickness of the circular piece to generate an electrical power field with a value of 3·10⁵ to 3·10⁶ V/m.
